(19) United States
(12) Patent Application Publication
(10) Pub. No.: US 2001/0027464 A1
(43) Pub. Date: Oct. 4, 2001

(54) Operating system abstraction interface for broadband terminal platform firmware

(75) Inventors: Donald Tavoletti, Warrington, PA (US); Chris Del Sordo, Souderton, PA (US); Jack M. Birnbaum, Southampton, PA (US); Jeffrey T. Davis, Doylestown, PA (US)

Correspondence Address: Barry R. Lipsitz, Law Offices of Barry R. Lipsitz, 755 Main Street, Building 8, Monroe, CT, 06468, US

(73) Assignee: GENERAL INSTRUMENT CORPORATION, Horsham, PA (US)

(21) Appl. No.: 09/798,351

(22) Filed: Mar. 2, 2001

Related U.S. Application Data
(63) Continuation-in-part of application No. 09/535,899, filed on Mar. 27, 2000.

(51) Int. Cl. G06F 9/00; G06F 9/44; G06F 15/163; G06F 9/54

(52) U.S. Cl. 709/103; 709/310; 709/315

(57) ABSTRACT

A method and apparatus for providing an operating system abstraction interface for a set-top television terminal used within a broadband environment. The interface defines an OS independent layer that abstracts the services that are needed to implement the set-top firmware in an OS independent manner. The present invention provides several constructs that are unique to the broadband environment. These include a synchronization feature, a clock feature and Inter-process naming tags that are provided such that the interface of the present invention may be adapted for both process based operating systems and non-process based operating systems.

This application is a continuation-in-part of commonly assigned, co-pending U.S. patent application Ser. No. 09/535,899 filed on Mar. 27, 2000.

### FIELD OF THE INVENTION

The present invention relates to an interface for platform firmware and software in a broadband terminal/user appliance, such as those used in cable and satellite television networks. In particular, the invention provides a method and apparatus for abstracting the operating system kernel from higher-level platform software, such that the platform firmware and software will work on top of multiple, dissimilar operating systems. The invention also provides constructs used by broadband terminal platform firmware.

### BACKGROUND OF THE INVENTION

The recent advent of digital set-top terminals has spurred the growth of subscriber television networks, such as cable/satellite television networks. Such terminals can support increased levels of programming services and a variety of software-based applications/functions, such as an electronic program guides, stock or weather banners, shopping and bank-at-home services, games, and the like. Moreover, this trend is expected to continue with the convergence of telephone, television and computer networks, and the rise of in-home computer networks. Despite its name, the “set-top or broadband terminal,” also known as a decoder, can be located anywhere near a television, or may have its functions built into the television.

Conventionally, it is typical for different firmware to be implemented for each different operating system (OS) platform that will run on the Broadband terminal. This is a problem in conventional systems because the platform software needs to be changed (i.e., recompiled, ported, etc.) for each type of OS that it would be run on. This disadvantageously creates the need to maintain different versions of functionally equivalent code because it is desirable that the broadband terminal platform software be the same across all OS environments. It is noted that the broadband platform software controls all the hardware devices and supports all the associated communication protocols that are used to process downstream and upstream messaging and digital television services.

However, there is a need for different operating system environments, because each environment brings strategically different software feature offerings. Cable “multiple system operators” (MSOs) will want to offer different feature sets to their customer base. For example, a Microsoft operating system environment will bring a more “PC like” software environment, whereas a Liberate OS environment would not. In addition to the above, continual operating system changes in terminals will be the result of improvements, cost reductions (i.e., new CPUs), new components (i.e., new memory configurations), and second source manufacturers. This is problematic since it creates confusion and requires a tremendous amount of work to maintain the platform software. This in turn means that software/firmware must be developed and downloaded to the terminals, which leads to additional expense for the MSO. The development cycle for firmware can be lengthy and costly for the MSO since they must maintain a fielded population in the hundreds of thousands of terminals.

Another problem of conventional systems is that it is difficult to add strategic OS functionalities that are used within the broadband environment. In particular, conventional operating systems fail to adequately provide the platform software the many required constructs that are necessary in the broadband environment.

Accordingly, it would be desirable to allow a television network operator to use different set-top operating systems which are compatible with a common, generic (e.g., operating-system independent) set of firmware. Keeping this vital core code intact means more stable code, which is an extremely important feature in code that will reside in millions of households. It is also desirable to make available the necessary constructs to the platform software such that all operating systems support a common set of functionalities within the broadband environment.

In view of the above, the present invention provides a system that overcomes the limitations of the prior art and has advantages, as described below, that will become evident to those of ordinary skill in the art.

### SUMMARY OF THE INVENTION

According to an aspect of the present invention, there is provided a method for enabling communication between platform software and a particular operating system executing on a broadband terminal operating within a broadband environment. The method comprises providing an operating system abstraction interface having an operating system dependent layer and an operating system independent layer, between the platform software and the operating system; and providing constructs within the operating system abstraction interface for synchronizing threads, coordinating timing and providing Inter-Process naming. The operating system abstraction interface enables the platform software to run on dissimilar operating systems while maintaining consistent functionality across the dissimilar operating systems.

According to a feature of the invention, the operating system abstraction interface may include a thread function for creating and starting control threads for different functionalities of the platform software, and a synchronizer function for providing initialization and synchronization of the threads. The thread function may enable a priority of at least a particular one of the threads relative to other ones of the threads to be changed, and may enable execution of at least a particular one of the threads to be suspended by starting the particular thread in a suspended state, while also enabling execution of the particular thread to subsequently be resumed. The synchronizer function may cause at least a particular one of the threads to pause execution until all threads that are registered with a synchronizer have reached a synchronization point.

According to another feature, the operating system abstraction interface includes a mutex function for inverting the priority of at least a particular one of the threads so that, when a first task associated with the particular thread initially has a lower priority, and owns a resource that a second, higher priority task associated with another one of the threads is waiting on, the priority of the first task is temporarily raised to the higher priority until the first task releases the resource.

According to a further feature, the operating system abstraction interface may include a timer function for notifying threads that a time interval has passed.

According to yet another feature, the operating system abstraction interface includes a message function for allowing objects to carry intertask or intratask information.

According to another feature of the invention, the platform software comprises firmware for the terminal.

According to another aspect of the invention, there is provided a terminal for use within a broadband environment that includes a plurality of input ports that receive downstream data, a computer readable medium having executable computer program code resident thereon that includes an operating system abstraction interface between platform software and an operating system executing on the terminal, and a processor for executing the computer program code.

A portion of the operating system abstraction interface is independent of the operating system and the operating system abstraction interface may provide constructs for synchronizing threads, coordinating timing and providing Inter-Process naming. The operating system abstraction interface enables the platform software to run on dissimilar operating systems while maintaining consistent functionality across the dissimilar operating systems.

### BRIEF DESCRIPTION OF THE DRAWINGS

The foregoing summary, as well as the following detailed description, is better understood when read in conjunction with the appended drawings. For the purpose of illustrating the invention, like references numerals represent similar parts throughout the several views of the drawings, it being understood, however, that the invention is not limited to the specific methods and instrumentalities disclosed. In the drawings:

FIG. 1 is a block diagram of a set top terminal's various input ports and protocols supported by the set top platform software in accordance with the present invention;

FIG. 2 is a class diagram that depicts the high-level class inheritance structure that achieves the abstraction of the OS independent level from the OS dependent level in accordance with the present invention;

FIG. 3 is a class diagram for classes “Thread”, “Synchronizer”, “SyncThread”, “MessageQueue”, and “MultiOrEvent” in accordance with the present invention;

FIG. 4 is a class diagram for classes “Clock” and “ATime,” that provide time services in accordance with the present invention;

FIG. 5 is a class diagram for a class “Mutex”, which is a synchronization primitive, in accordance with the present invention;

FIG. 6 is a class diagram for classes “Timer”, “Event” and “MultiOrEvent” in accordance with the present invention; and

FIG. 7 is a class diagram for a class “Message”, which designates inter-task or intra-task information, in accordance with the present invention, and a class diagram for a class “ThrottlingMessageQueue”, which designates that a queue is about to become full, in accordance with the present invention.

### DETAILED DESCRIPTION OF THE INVENTION

The present invention relates to a method and apparatus for providing an abstraction layer in the hierarchical structure of a broadband terminal to enable the platform firmware to be compatible with different operating systems and to provide the needed OS constructs required in the broadband environment.

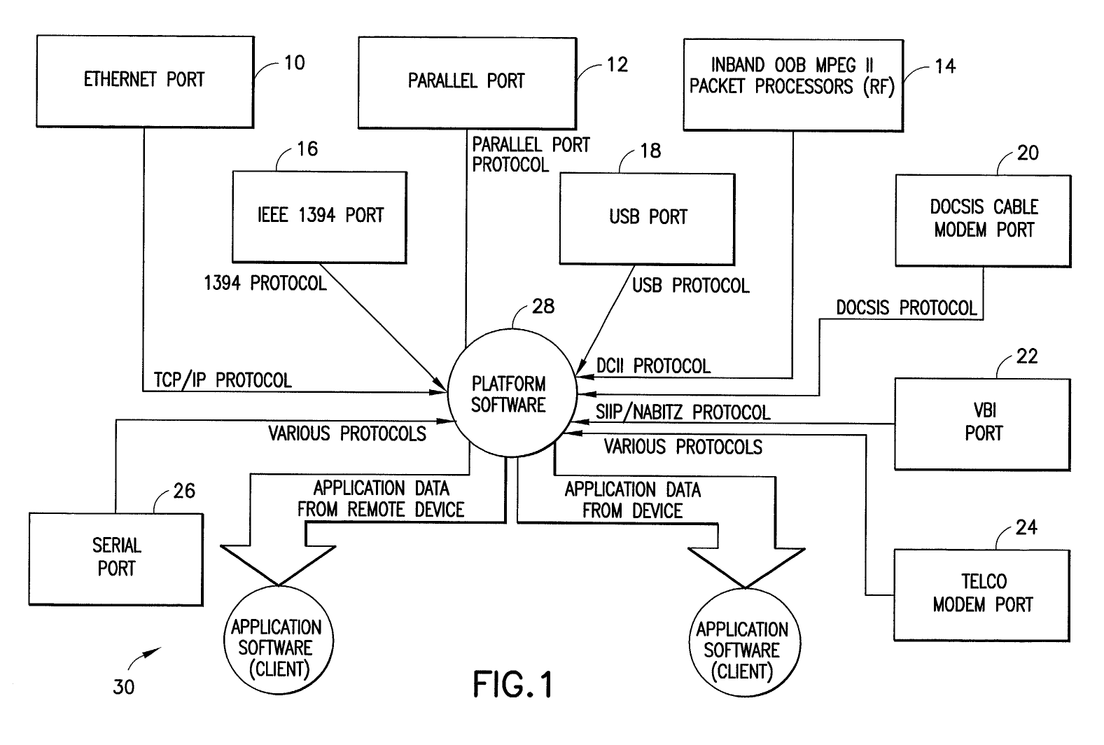

Referring to FIG. 1, there is illustrated an exemplary broadband terminal 30 within which the present invention may be implemented. One such terminal 30 is the DCT5000, manufactured by Motorola, Inc. of Horsham, Pa., USA. The Broadband terminal 30 has many input ports through which messages may be received. As can be seen in FIG. 1, these messages may be communicated to the broadband terminal 30 via various differing communication paths, such as in-band or out-of-band packet processor ports 14, Ethernet port 10, DOCSIS Cable Modem Port 20, USB port 18, parallel port 12, VBI (Vertical Blanking Interval) port 22, telephone modem port 24, serial port 26, or IEEE 1394 (Firewire) port 16. FIG. 1 also shows that platform software 28 in the broadband terminal 30 provides support for an assortment of communication protocols in order to receive this data. Examples of the supported protocols include: DigiCipher II (DCII) and Motion Picture Experts Group (MPEG II), Data Over Cable System Interface Specification (DOCSIS 1.1), Ethernet, SLIP, USB, NABITZ, IEEE1394 and various phone modem protocols.

The capabilities of the set-top extend beyond typical digital television services, because it can interface to a PC via Ethernet 10, Parallel 12 or USB 18 ports. It can also interface to home-networking equipment such as a video camera via, e.g., an IEEE 1394 port 16, which is expected to enable a variety of new applications that will run on the Broadband terminal 30.

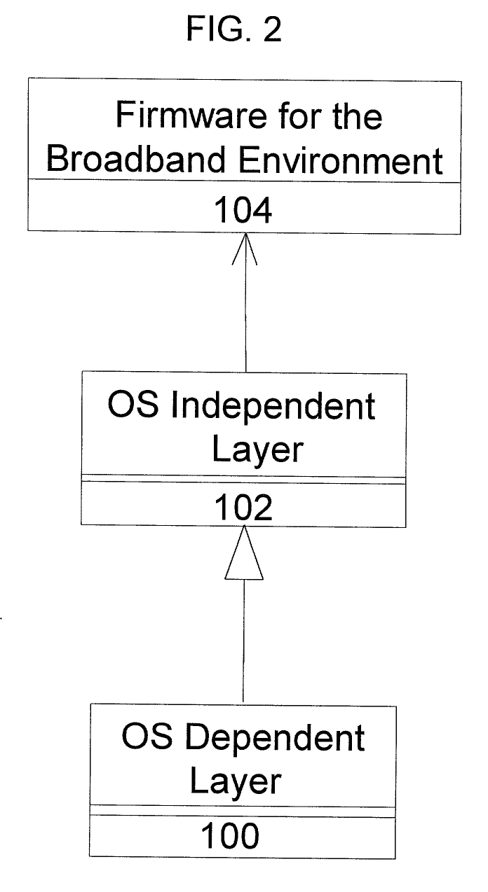

Referring now to FIG. 2, there is illustrated the OS interface of the present invention. The OS interface has a hierarchical structure wherein functions are separated according to their level of abstraction. The least abstract level in the OS interface is a kernel specific (OS dependent) layer 100, while the most abstract level is typically the firmware layer 104 where client applications operate independent of a specific hardware or OS environment. This firmware layer 104 is preferably versatile enough to provide all the functionality needed for applications that run in the Broadband environment.

In accordance with the present invention, the OS dependent layer 100 of each class implements an OS independent layer 102 in a manner that is appropriate for the particular OS using the actual kernel calls provided by the OS. Compilation of the software object for a particular OS will determine which OS dependent object is used. In other words when the code is compiled, the appropriate library for the specific OS is selected, e.g., WinCE, VRTX, etc. Moreover, software for the kernel interface is preferably written so that the parameters and return values are generic, and independent of any one OS.

The interface is preferably specified using object-oriented classes because that provides an easy way to abstract the OS independent layers 102 from the OS dependent layers 100. Since the lower layers (OS dependent) 100 must carry out the OS functions detailed in the upper layers (OS independent) 102 the OS dependent layers 100 inherit from the OS independent layers 102. Thus, it is preferable that the interface is implemented using object-oriented programming and analysis techniques, including Java or C++ programming languages. In addition, the interface should be usable with virtually any type of operating system, including, but not limited to, Windows CE, VRSTX, VXWorks, Linux and so forth.

Another aspect of the present invention is that it must provide capabilities to the firmware 104 such that the firmware 104 may operate on top of various dissimilar OSs, e.g., Windows CE, VRTXSA, VXWorks, Linux, etc. In particular, the interface is defined to provide critical features for platform software 28 that runs in a broadband environment. These critical features include specific constructs and support code that are not provided in conventional OS environments. These conventional OS environments must be accommodated since many of these operating systems will be deployed by Cable operators (MSOs) in their particular Broadband environments.

The present invention advantageously provides several constructs that are unique to the broadband environment. Since there is a large amount of inbound data that is simultaneously directed to the terminal 30, it is important that a synchronization feature be made available by the underlying operating system. A clock feature is necessary to allow for differing local time bases, as terminals 30 are often controlled at a national level. Additionally, Inter-process naming tags are provided such that the interface of the present invention may be adapted for both process based operating systems and non-process based operating systems. Each of the above constructs will now be described in greater detail.

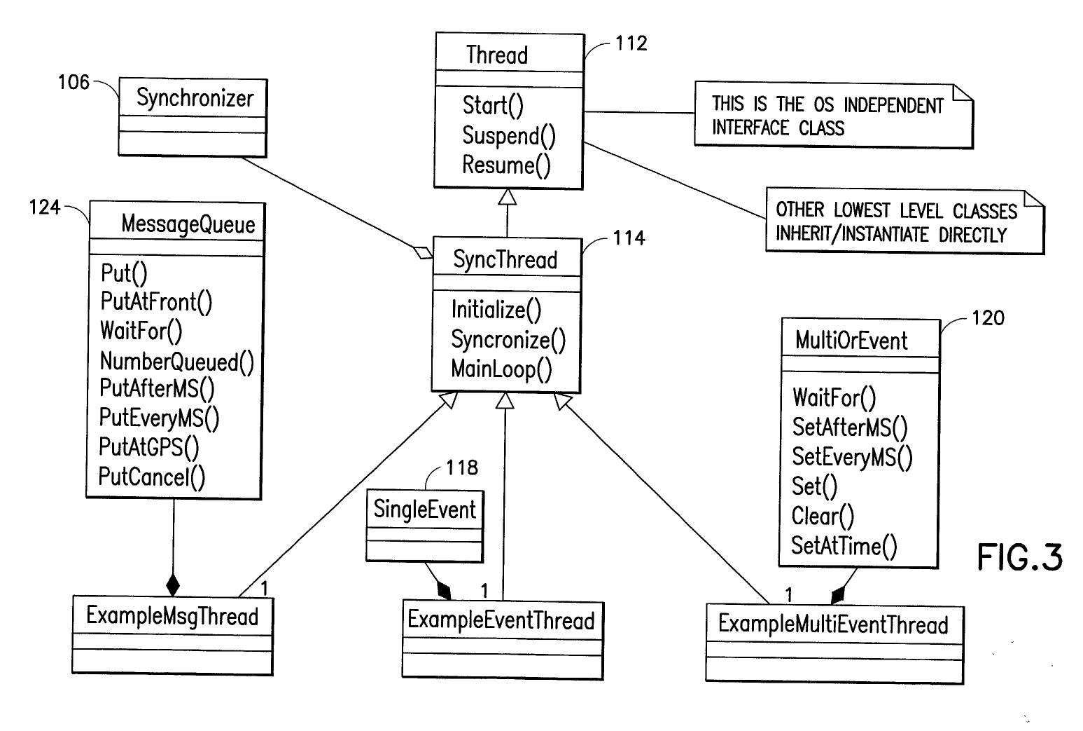

As can be seen by FIG. 1, data may be received by the terminal 30 via one or more of several ports 10, 12, 14, 16, 18, 20, 22, 24 and 26. It is challenging to make sure all of the threads are ready to process the inbound data in the appropriate order. For example, if one part of the code base is not ready to process these requests, this may have a negative impact on a particular request. Thus, it is desirable to synchronize the inbound data. Accordingly, as illustrated in FIG. 3, the present invention provides a synchronizer object 106 that is used to make sure all aspects of the Broadband terminal platform's software 28 are ready to start processing the onslaught of messaging that is continually sent downstream to the terminal 30.

The synchronizer object 106 is required in the broadband environment to coordinate all of the threads that need to be ready to handle all of the downstream requests being transmitted to a consumer's broadband device (terminal 30). Also, the need arises to process a combination of downstream messages in a particular order. The synchronizer object 106 enables this processing to occur in the correct order.

A Synchronizer class allows multiple threads to pause execution until all threads 112 that are registered with a synchronizer have reached a synchronization point. This coordinates all the thread objects 112 before they can continue to run. Typically, threads 112 that are synchronized together by sharing the same synchronizer class depend on each other to carry out their intended functions. These threads 112 need to be sure that the other threads 112 they depend on are in a satisfactory state. This is especially necessary after a power cycle of the terminal 30, which causes all the threads 112 to start up. What makes this feature more crucial in the broadband environment is that a single thread 112 or group of threads 112 process messages from the head-end, along with the fact that many messages are sent downstream simultaneously due to the nature of the broadband environment.

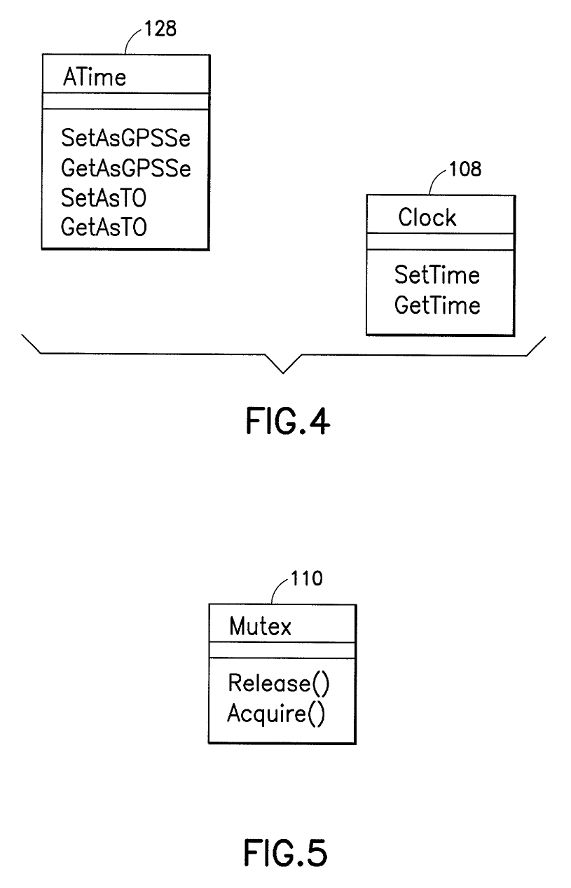

Referring now to FIG. 4, a second construct for use within the broadband environment is a clock object 108. The clock object 108 provides GPS, UTC and local time, which are utilized extensively in the broadband environment. Typically, this provision requires extending the functionality provided in a conventional OS. The clock object 108 provides local time support, which advantageously enables applications such as TVGUIDE On Screen to be presented in terms of local time. The clock object 108 also provides GPS and UTC time support, as these time bases are used for the national control system. This support enables broadband environment addressable controllers to send messages to terminals 30 that may reside in different time zones in different states. Addressable controllers send messages that activate certain functionalities, such as turning-on a TV service at a specific GPS time or blacking-out a program at a specific time. For these messages, local time base control does not work, whereas GPS and UPC time bases are designed to work over wide territories. The ATime class 128 of FIG. 4 is discussed hereinafter.

The third OS construct that is provided in an OS interface for the Broadband environment is Inter-Process naming tags for various OS constructs. The OS abstraction layers 100 and 102 of the present invention advantageously operate with both process-based environments (e.g., Windows CE) and non-process-based environments (e.g., a typical real-time operating system, or RTOS). The key here is that the inter-process mechanism be OS independent in nature regardless of the actual operating system that is below the OS abstraction layer. Some OS's have processes and some do not, so it is also necessary to be sure that the inter-process name tags work in both operating environments.

In achieving the advantageous features of the present invention, several OS independent classes are defined below. The Thread class 112 (FIG. 3) is provided for creating and starting control threads for different functions of the set-top firmware 104. A thread can be started in a suspended state if desired, where its execution is suspended, and subsequently its execution can be resumed. A priority of the thread relative to other threads can be changed. Threads carry-out downstream message processing and API call execution, which usually results from the consumer interacting with some peripheral of the terminal 30. A SyncThread class 114 provides initialization and synchronization of the threads and designates a main loop for an object.

Certain control objects, such as mutexes 110 (FIG. 5), are named so that two different threads in two different processes can acquire the mutex 110 by name. The Mutex class 110 can invert the priority of a thread 112 so that, when a lower priority task owns a resource that a higher priority task is waiting on, the priority of the lower priority task is temporarily raised to the higher priority until the resource is released.

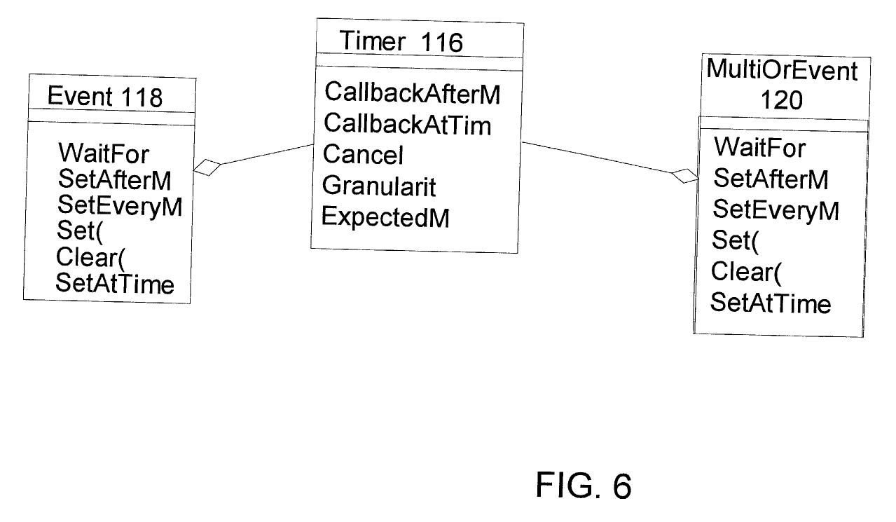

Referring to FIG. 6, a Timer class 116 provides notification that a time interval has passed. Notification mechanisms such as this are used to provide wakeup calls to threads 112 that are pending on time related events. The clock object class 108 of FIG. 4 is a component of the timer object 116. An Event class 118 controls the setting and clearing of events. Events may be used when a thread 112 is sent an event 118 from, e.g., an Interrupt Service Subroutine. This particular thread would wake up when receiving this event 118 and carries out the necessary processing that is specific for that interrupt.

A Critical Section class (not shown) provides protection for critical sections of code. Critical sections are used to coordinate two threads 112 that use the same memory location. Only one thread can read or write to this memory location at any one time. A MultiOrEvent class 120 illustrated in FIG. 6 declares that a synchronization is satisfied when one or more events are asserted. With a MultiOrEventAll class (not shown), all events that are asserted at the time the synchronization is satisfied are returned to the caller.

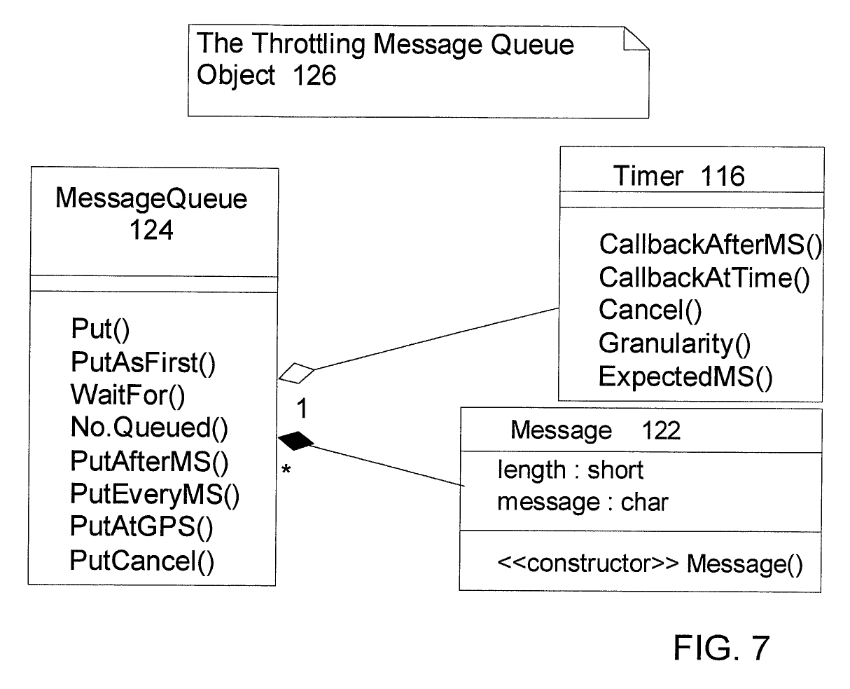

Referring to FIG. 7, a Message class 122 enables objects to carry intertask or intratask information. A MessageQueue class 124 provides a container for messages. Messages are an exemplary approach to transfer data from one thread 112 to another. A Throttling Message Queue 126 is similar, but informs the user that the queue is about to become full (i.e., the throttling state). This mechanism is used when the software design provides a way to stop these incoming messages from being put on the queue when the queue is overflowing.

Referring again to FIG. 4, an A Time class 128 provides a time value, while the Clock class 108 provides the basic clock functions. The clock class 108 functions to provide the time of day function to the higher level software. Interthread communication is provided via the message queue 124, mutex 110 and/or event 118.

It should now be appreciated that the present invention provides a unique approach that allows set-top firmware to be implemented only once, while being usable under several operating systems and set-top platforms in the broadband environment. The present invention further provides an interface that allows the sharing of architecture and code across OS platforms and hardware platforms that includes the new strategic features as defined above that are needed in the Broadband environment.

It is noted that the foregoing examples have been provided merely for the purpose of explanation and are in no way to be construed as limiting of the present invention. While the invention has been described with reference to preferred embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A method for enabling communication between platform software and a particular operating system executing on a broadband terminal within a broadband environment, comprising the steps of:
providing an operating system abstraction interface, comprising an operating system dependent layer and an operating system independent layer, between the platform software and the operating system; and
providing constructs within the operating system abstraction interface for synchronizing threads, coordinating timing and providing Inter-Process naming,
wherein the operating system abstraction interface enables the platform software to run on dissimilar operating systems while maintaining consistent functionality across the dissimilar operating systems.

2. The method of claim 1, wherein the operating system abstraction interface includes a thread function for creating and starting control threads for different functionalities of the platform software, and a synchronizer function for providing initialization and synchronization of the threads.

3. The method of claim 2, wherein the thread function enables a priority of at least a particular one of the threads relative to other ones of the threads to be changed, and wherein the thread function enables execution of at least a particular one of the threads to be suspended by starting the particular thread in a suspended state, and enables execution of the particular thread to subsequently be resumed.

4. The method of claim 2, wherein the synchronizer function causes at least a particular one of the threads to pause execution until all threads that are registered with a synchronizer have reached a synchronization point.

5. The method of claim 2, wherein the operating system abstraction interface includes a mutex function for inverting the priority of at least a particular one of the threads so that, when a first task associated with the particular thread initially has a lower priority, and owns a resource that a second, higher priority task associated with another one of the threads is waiting on, the priority of the first task is temporarily raised to the higher priority until the first task releases the resource.

6. The method of claim 1, wherein the operating system abstraction interface includes a timer function for notifying threads that a time interval has passed.

7. The method of claim 1, wherein the operating system abstraction interface includes a message function for allowing objects to carry intertask or intratask information.

8. The method of claim 1, wherein the platform software comprises firmware for the terminal.

9. A terminal for use within a broadband environment, comprising:
a plurality of input ports adapted to receive downstream data;
a computer readable medium having executable computer program code resident thereon, the computer program code comprising an operating system abstraction interface between platform software and an operating system executing on the terminal; and
a processor for executing the computer program code,
wherein:
a portion of the operating system abstraction interface is independent of the operating system,
the operating system abstraction interface provides constructs for synchronizing threads, coordinating timing and providing Inter-Process naming, and
the operating system abstraction interface enables the platform software to run on dissimilar operating systems while maintaining consistent functionality across the dissimilar operating systems.

10. The terminal of claim 9, wherein the operating system abstraction interface includes a thread function for creating and starting control threads for different functionalities of the platform software, and a synchronizer function for providing initialization and synchronization of the threads.

11. The terminal of claim 10, wherein the thread function enables a priority of at least a particular one of the threads relative to other ones of the threads to be changed, and wherein the thread function enables execution of at least a particular one of the threads to be suspended by starting the particular thread in a suspended state, and enables execution of the particular thread to subsequently be resumed.

12. The terminal of claim 11, wherein the synchronizer function causes at least a particular one of the threads to pause execution until all threads that are registered with a synchronizer have reached a synchronization point.

13. The terminal of claim 10, wherein the operating system abstraction interface includes a mutex function for inverting the priority of at least a particular one of the threads so that, when a first task associated with the particular thread initially has a lower priority, and owns a resource that a second, higher priority task associated with another one of the threads is waiting on, the priority of the first task is temporarily raised to the higher priority until the first task releases the resource.

14. The terminal of claim 9, wherein the operating system abstraction interface includes a timer function for notifying threads that a time interval has passed.

15. The terminal of claim 9, wherein the operating system abstraction interface includes a message function for allowing objects to carry intertask or intratask information.

16. The terminal of claim 9, wherein the platform software comprises firmware for the terminal.
